(19) United States
(12) Patent Application Publication
(10) Pub. No.: US 2005/0092727 A1
(43) Pub. Date: May 5, 2005

(54) Independent electronics equipment heater using phase width modulation

(76) Inventors: Peter Donald Fraley, Minneapolis, MN (US); Ronald Allen Major, Prior Lake, MN (US); Tim John Larson, Elk River, MN (US); Slava Gekht, Rosemount, MN (US); Rodney Elmer Berg, Plymouth, MN (US); Richard Norman Vignes, St. Louis Park, MN (US); Jeffrey Scott Haider, Golden Valley, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/807,522

(22) Filed: Mar. 22, 2004

Related U.S. Application Data
(60) Provisional application No. 60/456,362, filed on Mar. 20, 2003.

(51) Int. Cl. H05B 1/00; H05B 3/00

(52) U.S. Cl. 219/209; 219/201

(57) ABSTRACT

The invention provides an apparatus comprised of a heater system used for a mass data storage module. The system is configured to maintain the correct operating temperature for drives of the module when the ambient temperature and/or initial, starting temperature is outside of the range of temperatures required for reliable operation of the drives and as appropriate, to report issues to a user via in-band (i.e., the host system data path) and out-of-band (supplemental user communication links) interfaces. Pulse width modulation is used in distributing heat across the drives with the implementation of a rotating “seed” methodology, rather than a variable duty cycle.

### RELATED APPLICATIONS

The present Application claims the benefit of U.S. Provisional Patent Application, Ser. No. 60/456,362, filed Mar. 20, 2003. The entire disclosure of the above-mentioned patent application is hereby incorporated by reference herein.

### FIELD OF THE INVENTION

The invention relates to computer mass data storage peripherals, and in particular, to equipment heaters for such peripherals.

### BACKGROUND OF THE INVENTION

In military, security, multimedia, telemetry, medical, reconnaissance, and other applications, there is often a need to operate storage media in extreme environments. In these applications, scenarios can exist in which the data medium for these systems may need to be accessed in extreme cold temperatures. As such, prior to system startup, the data medium would need to be rapidly and deterministically restored to an operational temperature. The data medium is usually in the form of magnetic hard disk drives, which in all likelihood, comprise the most thermally-sensitive components in the system. Thus, there exists a need to store and operate equipment in cold environments. This need is confirmed by specifications that have been created to define these environments. In addition, standardized testing requirements have been created to certify equipment made to work in such environments.

For instance, the MIL-STD-810F military specification's laboratory test method 502.4-9 for low temperatures defines design types for various local environments with the following categorical designations: “Mild Cold (C0)”, “Basic Cold (C1)”, “Cold (C2)”, and “Severe Cold (C3)”. These categories essentially conform with those in MIL-HDBK-310 and NATO STANAG,-2895. They define induced conditions that are “extreme levels to which material may be exposed during storage or transit situations, such as inside an unventilated field storage shelter or a railway car” (MIL-STD-810F, footnote to Table 502.4-II). Further, the Army CGS (Common Ground Station) has Cold Temperature Profiles 1 and 2 that specify test parameters for extreme cold equipment storage and operational conditions. These tests involve multiple, timed intervals of humidity soaks, warm/cold temperature soaks and temperature ramps, as well as non-operational, powered pre-op preparation and fully operational phases.

All of these needs are addressed with this invention.

### SUMMARY OF THE INVENTION

In accordance with certain embodiments, an apparatus is provided comprising a heating system for a mass data storage system having a plurality of storage units. The heating system is integrated into the peripheral, fully automated, and user configurable. The invention preferably has capability for user and host software application communication with the mass storage system for continuous automated or remote manual control of all external physical interactions with the mass data storage system as well as pertinent internally-detected or internally-directed conditions, states and sequences. Multiple standardized software, firmware and hardware protocols would be preferably provided for these communication paths (e.g., in-band and out-of-band storage management utilities, SMTP event notifications, SNMP monitoring and administration, standardized in-band commands and feedback, LAN and WAN backbone layers, visual/audio indicators, IrDA interface, wireless communications, etc.).

In certain embodiments, a mass media storage system is provided comprising a housing and one or more heater elements. The housing is contained within a principal enclosure and comprised of a plurality of drives, where each of the plurality of drives is secured within a drive shuttle. The housing comprises an upper and a lower set of guide rail trays. Each drive shuttle is adapted for insertion between an unoccupied pair of upper-and lower guide rail trays. The one or more heater elements are each operatively coupled proximate to one of the plurality of drives via the guide rail trays.

In other certain embodiments, a computer drive pack assembly is provided comprising a principal enclosure including one or more fans, a drive pack, one or more heater elements, and an enclosure circuit. The drive pack is contained within the principal enclosure and comprised of a plurality of drives. The one or more heater elements is each operatively coupled proximate to one of the plurality of drives. The enclosure circuit is operatively contained within the principal enclosure, where the enclosure circuit is adapted to operatively control each of the heater elements and each of the fans.

In additional certain embodiments, a method is provided. The method involves achieving a correct operating temperature for one or more of a plurality of drives within a drive pack contained within a principal enclosure when an initial starting temperature is outside of a range of temperatures required for reliable operation of the drives. The method includes steps of monitoring the status of the plurality of drives, determining whether all criteria are met to start heat phase, engaging the heat phase if all the criteria are met, and determining whether the heat phase should be terminated.

In further certain embodiments, there is provided a computer readable medium comprising the instructions for performing the method of achieving a correct operating temperature for one or more of a plurality of drives within a drive pack contained within a principal enclosure when an initial starting temperature is outside of a range of temperatures required for reliable operation of the drives.

### BRIEF DESCRIPTION OF THE DRAWINGS

FIG. 1 is a schematic, front perspective view of a computer drive pack assembly in accordance with certain embodiments of the invention;

FIG. 2 is a schematic, front perspective view of the computer drive pack assembly of FIG. 1;

FIG. 3 is a schematic, front exploded perspective view of a drive pack in accordance with certain embodiments of the invention;

FIG. 4 is a schematic, front perspective view of a Drive Service Board in accordance with certain embodiments of the invention;

FIG. 5 is a schematic, front perspective view of an Enclosure Services Interface (ESI) Board in accordance with certain embodiments of the invention;

FIG. 6 is a schematic, front perspective view of a drive shuttle in accordance with certain embodiments of the invention;

FIG. 7 is a schematic, front perspective view of both the computer drive pack assembly of FIG. 1 and an individual drive in accordance with certain embodiments of the invention;

FIG. 8 is a schematic, front perspective view of a set of lower guide rail trays in accordance with certain embodiments of the invention;

FIG. 9 is a schematic, side perspective view of a guide rail tray with heater element connected thereto in accordance with certain embodiments of the invention; and

FIG. 10 is a flow diagram for the heater system.

### DETAILED DESCRIPTION OF PREFERRED EMBODIMENTS

The following detailed description is to be read with reference to the drawings, in which like elements in different figures have like reference numerals. The drawings, which are not necessarily to scale, depict selected embodiments, but are not intended to limit the scope of the invention. It will be understood that many of the specific details incorporating the system illustrated in the drawings could be changed or modified by one of ordinary skill in the art without departing significantly from the spirit of the invention.

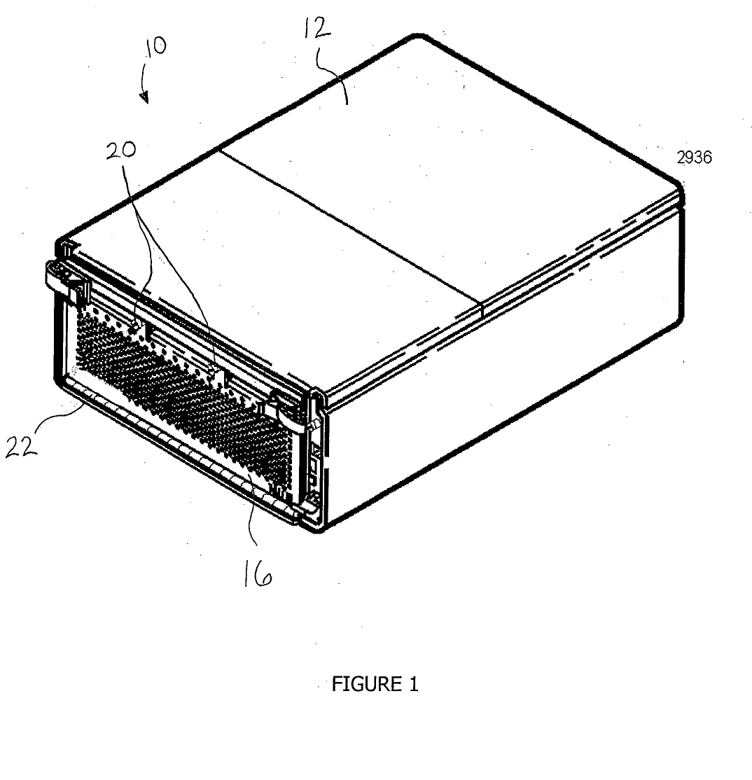

FIG. 1 illustrates a front perspective view of a computer drive pack assembly 10 in accordance with certain embodiments of the invention. The term “computer drive pack assembly” could be replaced by a number of relatively similar terms (e.g., computer peripheral apparatus, modular data device assembly, fault tolerant computing facility, etc.) that those skilled in the art would also recognize, however “computer drive pack assembly” will be used herein for conventional purposes and not with the intention of limiting the invention as such. As shown, the computer drive pack assembly 10 has a principal enclosure 12. The principal enclosure 12 is preferably comprised of sheet metal or the like for providing structural support and rigidity as well as EMI (Electromagnetic Interference) shielding. A drive pack 14 (not visibly shown) is within the enclosure 12. The term “drive pack” could be replaced by a number of relatively similar terms (e.g., mass-media storage system, disk carrier body, hard disk drive module, etc.) that those skilled in the art would also recognize, however “drive pack” will be used herein for conventional purposes and not with the intention of limiting the invention as such. In certain embodiments, the front of the drive pack 14 is covered with a drive protection panel 16. Such panel 16 is shown in its closed position.

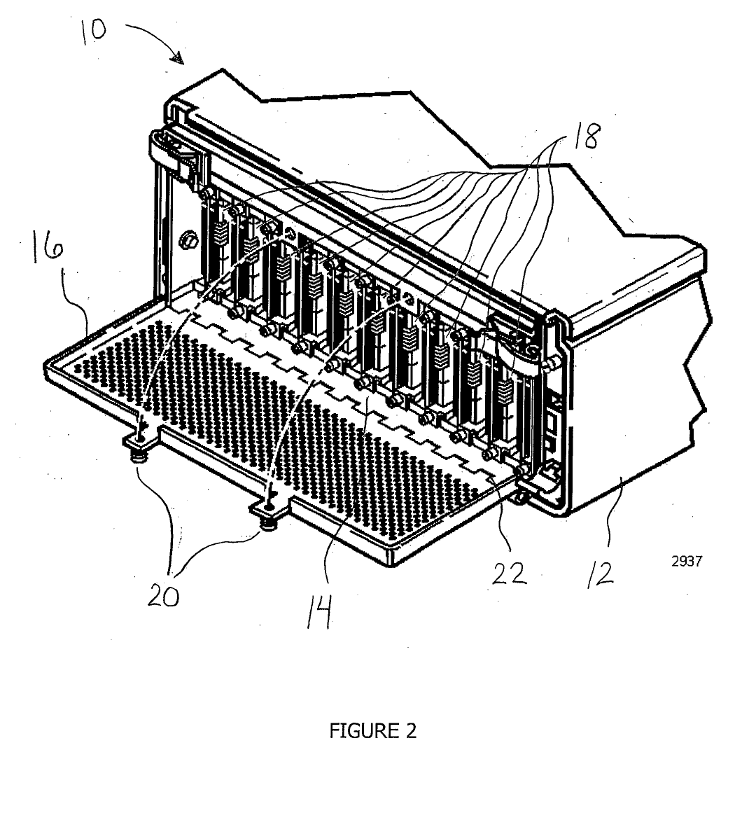

FIG. 2 shows a front perspective view of the drive pack assembly 10 with panel 16 in its open position. Consequently, the drive pack 14 is exposed. A plurality of individual drives 18 are contained within the drive pack 14, as illustrated. The term “drive” could be replaced by a number of relatively similar terms (e.g., random access memory device, hard disk module, mass storage device, etc.) that those skilled in the art would also recognize, however “drive” will be used herein for conventional purposes and not with the intention of limiting the invention as such. In certain preferred embodiments of the invention, referencing FIGS. 1 and 2, the drive protection panel 16 is secured at the top edge of the drive pack 14 with fasteners 20 and at the bottom edge of the drive pack 14 with a hinge 22. The drive protection panel 16 is provided as a door in order to physically protect the individual drives 18 inside the drive pack 14 while also allowing access to the drives 18.

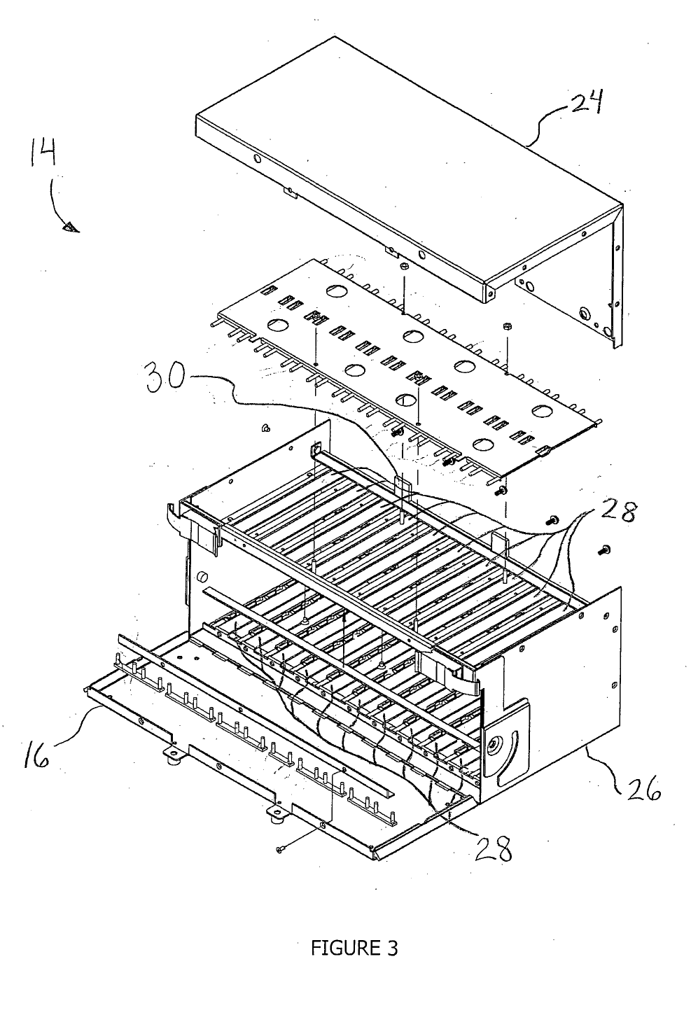

FIG. 3 shows a front exploded perspective view of framework of the drive pack 14 referenced in FIGS. 1 and 2. In certain embodiments, the drive pack 14 is comprised of a ruggedized construction with a parallelepiped external encasement of heavy gauge sheet metal having an upper portion 24 and a lower portion 26. Rigidity of the drive pack 14 is further enhanced with an internal framework preferably comprised of an upper set and a lower set of guide rail trays 28.

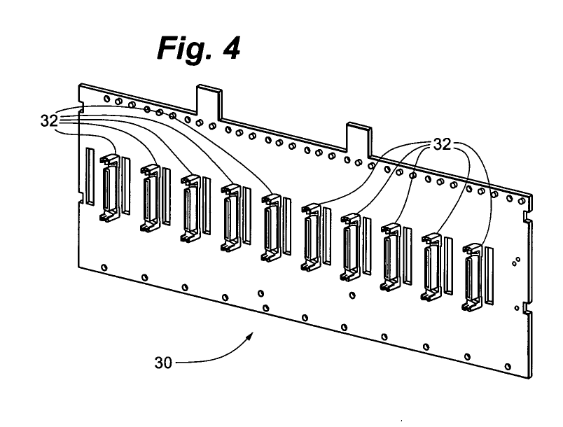

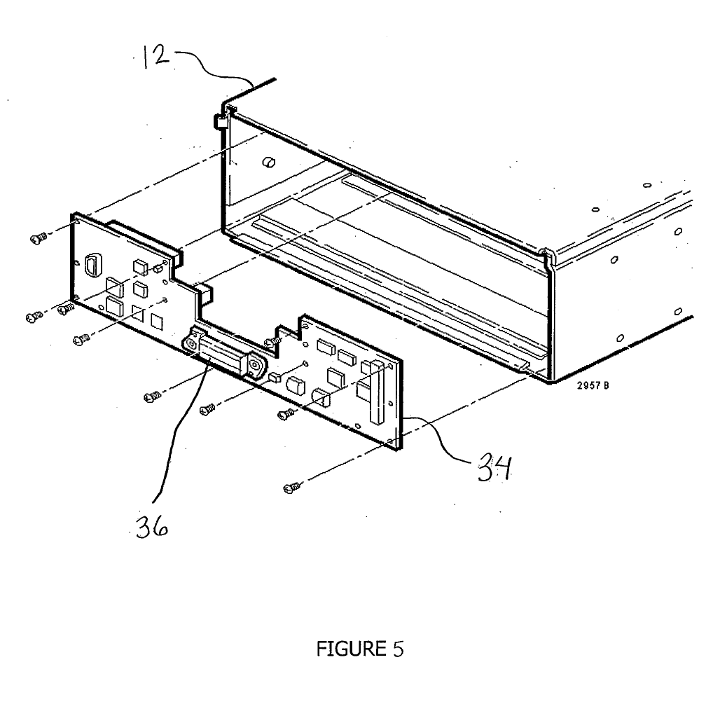

Also shown, yet obstructed by the upper set of guide rail trays 28 is a Drive Service Board 30, which is generally mounted at the rear of the drive pack 14. FIG. 4 shows a front perspective view of the Drive Service Board 30. In addition to supporting LEDs for lighted drive indicators, the Drive Service Board 30 comprises a circuit such as a printed circuit board (not shown) that includes the individual drive connections 32, control logic, monitoring logic, sensors, data bus channels, power distribution and control, heater power and status logic, LED control, and all other interconnections as described below for the entire drive pack 14. In turn, the Drive Service Board 30 has individual power and data bus bypass control to each of the drives 18, yet is managed by several processors and at least one control board in the principal enclosure 12 (FIG. 5). The Drive Service Board 30 makes its electronic signal and power connection to the principal enclosure 12 via an ultra-high insertion rated electronic signal and power connector (not visibly shown) that is preferably located at the rear of the drive pack 14. The connector is rated for high current transfer and forms the sole electronic signal and power interconnection (i.e., blind-mate connection) between the principal enclosure 12 and the drive pack 14.

As generally depicted in FIG. 5, at the rear of the principal enclosure 12, is an ESI (Enclosure Services Interface) printed circuit board 34, preferably oriented parallel to a rear surface of the inserted drive pack 14. In certain embodiments, the ESI Board 34 has a screw-mount configuration to internally couple to a framework of the principal enclosure 12. However, in other embodiments, the ESI Board 34 may comprise other mounting configurations, such as being a side-mounted field-replaceable unit requiring minimal tool-work for-extraction and exchange (e.g., held in place by clips, thumbscrews, etc.). The ESI Board 34 includes a female connector 36 which couples with the above-mentioned electronic signal and power connector of the drive pack 14. In turn, the ESI Board 34 functions as an interconnect between the drive pack 14 and the all the peripheral support modules of the computer drive pack assembly 10. Such peripheral support modules include at least one fan pack and at least one power supply (neither of which are visibly shown).

The ESI Board 34 provides DC power distribution and filtering, inter-module signal connectivity, enclosure services status and control processing, drive pack services (i.e., power, power control, redundant data bus distribution and bypass control logic, status and management processing, and environmental monitoring), and processing for a plurality of user interfaces. The ESI Board 34 has automated control of the Drive Service Board 30 via at least one embedded processor located on the ESI Board 34. Further, the ESI Board's control logic, status logic, and embedded microprocessors, working in concert with the electronics on the Drive Service Board 30, automate the heating, cooling, power, initialization, testing, and various electronic sequences involving the computer drive pack assembly 10.

As shown in FIG. 2, the drive protection panel 16 can be opened to provide full access to the plurality of drives 18. In certain embodiments, the drives 18 can be individually removed or inserted along the guide rail trays 28 contained within the sheet metal framework of the drive pack 14.

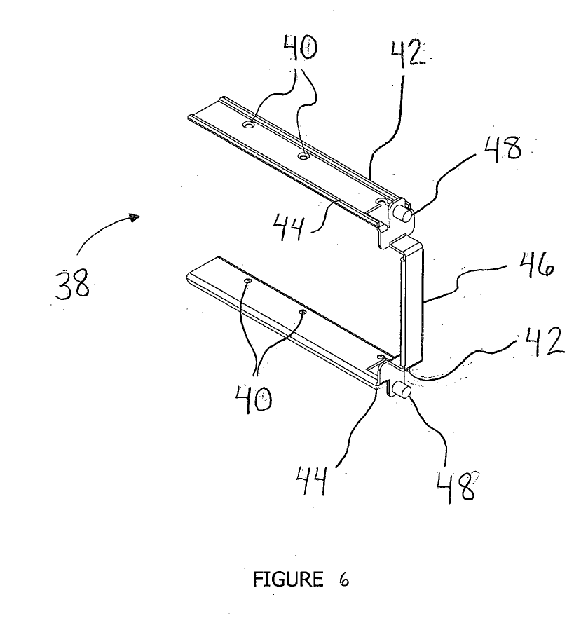

FIG. 6 illustrates a front perspective view of a drive shuttle 38 in accordance with certain embodiments of the invention. The drive shuttle 38 (shown without accompanying individual drive 18) consists primarily of a single-piece construction that is secured to a corresponding individual drive 18 via self-aligning fastening holes 40. The shuttle 38 integrates first and second dual vertical edges, 42 and 44 respectively, protruding from both a top surface and a bottom surface of the shuttle, and includes a handle 46 along a front surface. The shuttle 38 has tool-less bay frame fasteners 48 that function in securing the shuttle 38 to upper and lower internal framework crossbars of the drive pack 14.

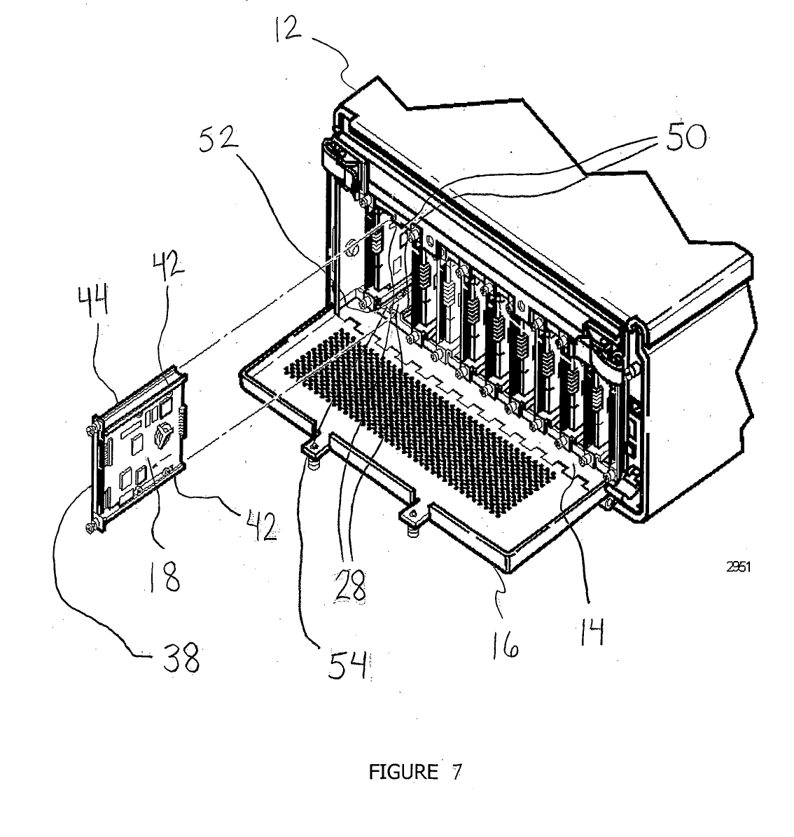

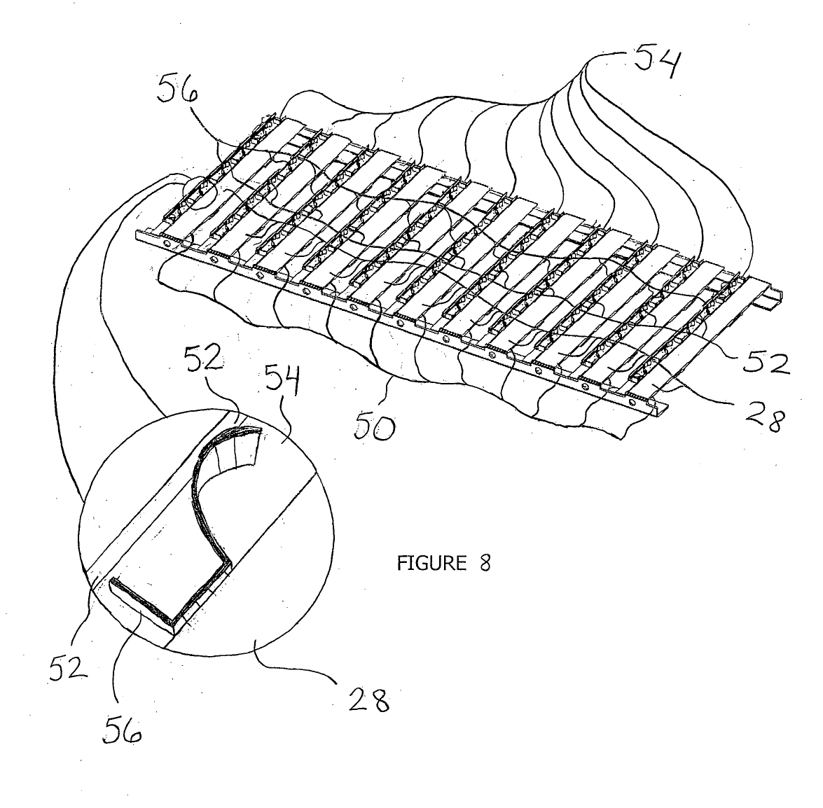

In reference to FIGS. 7 and 8, when inserting one such drive shuttle 38 (with individual drive 18 contained therein) in the drive pack 14, the first dual vertical edges 42 on the top and bottom of the shuttle 38 generally need to be aligned with corresponding top and bottom outer edges 50 of an unoccupied pair of guide rail trays 28 that lie within the drive pack 14. Likewise, the second dual vertical edges 44 on the top and bottom of the shuttle 38 generally need to be aligned with corresponding inner walls 52 of pressure slots 54 (only the lower pressure slot shown in FIGS. 7 and 8). In so doing, as the shuttle 38 is inserted, the first and second dual vertical edges 42 and 44 can respectively slide around the corresponding outer edges 50 of the trays 28 and adjacent to the inner walls 52 of the pressure slots 54, providing securement of the shuttle 38 within the drive pack 14. As previously mentioned in reference to FIG. 3, the internal framework of the drive pack 14 is comprised of the upper set and the lower set of guide rail trays 28. As depicted in FIG. 8, the second dual vertical edges 44 of each shuttle 38 are configured to fit into a pressure slot 54, one of which lies adjacent to each guide rail tray 28 for each drive 18. Each of the pressure slots 104 accommodates a series of curved metal finger springs 56 formed from a single piece of metal, e.g., steel, (see insert in FIG. 8) and attached to the underside of the immediately adjacent guide rail tray 28. The finger springs 56 function in pressing the shuttle second dual vertical edges 44 between the springs 56 and the inner surface 52 of the pressure slot 54 to hold the shuttle 38 (and the drive 18 contained therein). The pressure slots 54 serve three purposes. First, the slots 54 assure accurate alignment for the blind-mate power/signal connections being made to the Drive Service Board 30 at the rear of the drive pack 14 (industry standard blind-mate connectors are used). Second, the slots 54 provide multiple points of pressure contact which ensure solid grounding of the drives 18 along their full body length to the encasement of the drive pack 14, which provides a highly responsive EMI frequency return path that is necessary for EMI emission reduction. Third, the pressure slots 54 via the finger springs 56 hold the drives 18. securely along their lengths and act as strong vibrational dampeners, to address both inner drive resonance and external environmental input (an important consideration given the rugged deployment scenarios this invention may be utilized, in).

Once an individual drive 18 is installed, it preferably is powered on and enabled on the redundant back-end data buses. This is taken care of by the processor on the ESI Board 34 and the control circuitry on both the ESI Board 34 and the. Drive Service Board 30. The individual drive 18 then is brought online and tested. Finally, the drive 18 preferably needs to have redundant data rebuilt across its entire capacity, based on parity calculations made on the remaining drives' data, which is facilitated by a RAID controller as is known in the art. As is also known in the art, all of these processes are preferably done transparently to normal host system activity and its access to the invention's media data.

The computer drive pack assembly 10 is configured to maintain the correct operating temperature for the drives 18 when the ambient temperature and/or initial starting temperature is outside of the range of temperatures required for reliable operation of the drives 18 and as appropriate, to report issues to the user via the in-band (i.e., the host system data path) and out-of-band (supplemental user communication links) interfaces. In certain preferred embodiments, the assembly 10 would be configured to also inhibit the operation of the drives 18 if a proper operating temperature were not achieved. Preferably, the computer pack assembly 10 would include at least one heater element attached to a planar side of at least one of the upper or lower guide rail trays 28. In certain particular preferred embodiments, each heater element would be located on the outer planar side of the guide rail tray 28, whereas, each drive 18 would be in contact with the inner planar side of the guide rail tray 28. Preferably, each heater element would be attached to the guide rail tray 28 with either a wide thermal range glue or flush-mount screws. In certain particularly preferred embodiments, the at least one heater element would be covered by a thermally conductive, electrically nonconductive, wide thermal range material, and attached along the entire length and width of the tray to provide even heat distribution across the drive 18. It is appreciated that one skilled in the art could alternatively size the heater element accordingly (e.g., in terms of general length, width and thickness) so that the heater element could be used in place of the guide rail tray 28. As such, the heater element would be in direct contact with the drive 18. It is contemplated that the heater elements may have many alternative variations or implementations as such, and should not be construed or limited to any single most preferred embodiment.

A single temperature sensing point would preferably be used to simultaneously control the application of power to the at least one heating element, and the flow of current in the +12 V dc supply lead to the drive 18 would be inhibited if the sensed temperature were too cold or too hot. These functions would preferably be performed individually for each drive 18, however, the functions could just as well be performed for a particular region of the drive pack 14 in some embodiments. It is fully contemplated that in addition to the heater elements of the present invention, other devices such as Peltier Junctions may also be employed to both provide and remove heat.

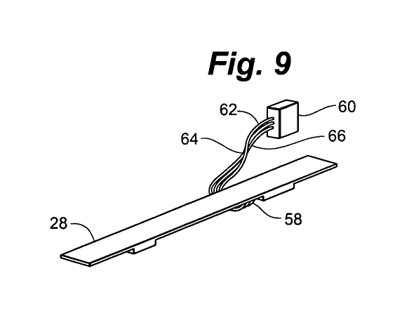

FIG. 9 illustrates a cross-sectional front view of one of the lower guide rail trays 28 having such an individual heater element 58 operatively coupled to the underside of the tray 28 and connected to a three wire connector harness 60. As mentioned above, optionally or in combination, at least one heater element 58 may likewise comprise or be operatively coupled to a topside of at least one of the upper guide rail trays 28. The guide rail trays 28, besides providing physical mounts for the heater elements 58, would subsequently serve a heating function for the drives 18 by conductively distributing heat evenly across the entire lower surface (and, optionally, the upper surface) of the drive shuttles 38. The trays 28 also act as a heat dispersal mechanism for convective heating of the drives 18 through the forced air movement induced via the plurality of fans mounted in the at least one fan pack and the fans mounted internally to the at least one power supply. The heater elements 58 preferably facilitate algorithmically induced heat distribution via pulse width modulation. A time/temperature feedback monitoring state machine is utilized with a circularly rotating seed-based pulse width modulation scheme described below for multi-level power control and even apportion of heat energy across the thermal conduction and convection distribution mechanisms mentioned above to prevent hot and cold spots from forming on the plurality of drives 18.

Each of the heater elements 58, as well as each of the fans of the invention, are preferably operated by a corresponding power FET (Field Effect Transistor) under control by the at least one processor on the ESI Board 34. In certain embodiments regarding the heater elements 58, a three wire system is used. FIG. 9 illustrates such a three wire system. The wires collectively enter a connector harness 60 that is connected to the Drive Service Board 30 (not shown) where the power FET's are mounted. A first wire 62 is used for source current, the second wire 64 is used as a center-tap reference, and a third wire 66 is used for ground return. Preferably, the processor on the Board 30 can turn power on or off to each heater element 58 (also contemplated as being the guide rail tray 28, as shown) via the respective power FET controlling the heater element 58. In doing so, and in using, for example, an analog-to-digital converter or a voltage comparator, voltage drop can be measured at the center-tap relative to the ground reference (i.e., providing the voltage potential at which the ground return wire resides). As such, the heater element 58 itself can be modeled as a large resistive element, preferably in the 30 to 40 watt range, with a center-tap. Using the information gathered from all the heater center-taps as described above, the processor can determine which heater elements 58 are functioning properly and report issues to the user via the in-band (i.e., the host system data path) and out-of-band (supplemental user communication links) interfaces. The information can also be used to determine if the heater elements 58 (i.e., if the computer drive pack assembly is configured to support heater elements) have been properly installed. Finally, the information can be used to further attempt to compensate if one or more of the heater elements 58 is not functioning by increasing PWM power in the control system as will be described below.

Although the heater elements described above and depicted in FIG. 9 suggest their use in the particular peripheral apparatus (i.e., the computer drive pack assembly) of the invention, the heating system detailed herein should not be limited in scope to this specific system configuration. It is contemplated that those skilled in the art could easily adapt this disclosed heating element hardware to any mass data storage apparatus, and could execute these disclosed procedures whenever appropriate (e.g., during system initialization, periodically during run-time operations, when manually requested by the user or host system, etc.) including, when desirable storage control based on operating temperature is warranted.

In certain preferred embodiments of the invention, a plurality of temperature sensors (not shown) are mounted on the Drive Services Board 30 and on circuit boards inside the principal enclosure 12 which are operatively coupled to a processor on the ESI Board 34. In turn, the ESI Board 34 would monitor whether the need for heating the drives 18 exists. In certain particularly preferred embodiments, the sensors are used for closed loop feedback in adjusting the levels of heat output and forced air convection during the heating procedure, generally referred to herein as the “heat-phase”.

In the following discussion, a heat-phase initiation analysis, and subsequent heat-phase execution, are described for a drive pack 18. The discussion references sections of multiple programming language independent routines as a preferable guide to the command flow for the processor on the ESI Board 34. In certain embodiments of the invention, four modules or routines would be utilized, and these routines would preferably include a DPS (Drive Pack Service) routine, a HPC (Heat) routine, a H-PWM (Heat Phase Control for Heater Elements), and a F-PWM (Heat Phase Control for Fans).

It should be appreciated that a wide number of programming languages could have been used to create a further number of computer programs each of which could be used to perform one or more of the heating system's desired functions. The parameters of such routines can be created before, during, or after the creation of such computer programs. The modules or routines are referenced herein to suggest a possible implementation of the computer program of the heater system, although the computer program or programs may be implemented in various ways, including monolithic computer programs, object-oriented programs, interpreted languages, or various other programming methods that result in functionally equivalent methods.

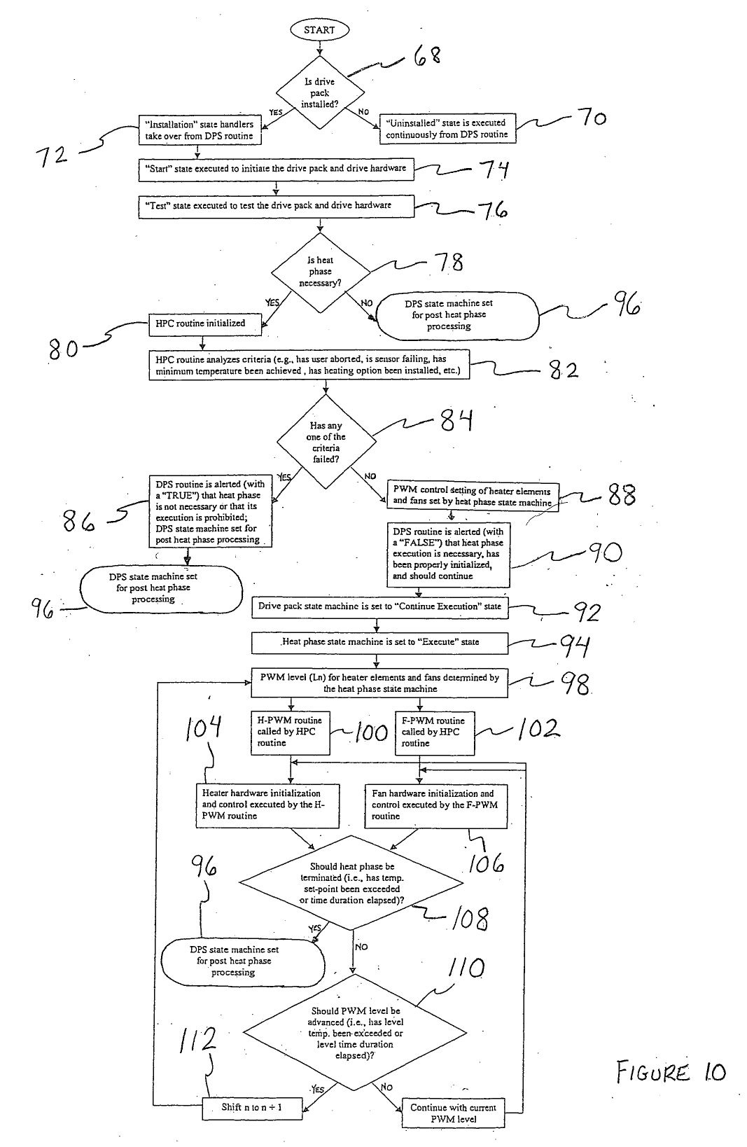

FIG. 10 is a flow diagram for the heater system. In certain preferable embodiments of the invention, the ESI processor would execute the DPS routine from a central idle-loop or as a preemptive RTOS (Real Time Operating System) process. Preferably, the DPS routine is primarily a state machine whose state handlers exist as cases in the switch. When there is recognition that no drive pack 14 is installed in Step 68, an “uninstalled” state is preferably executed continuously in step 70. When a drive pack 14 is detected as present in the principal enclosure 12 in Step 68, the installation state handlers preferably take over in Step 72. “Start” and “test” states in respective steps 74 and 76 are preferably executed in sequence to initialize and test the drive pack 14 and drive hardware.

Subsequently, the HPC routine is preferably initialized in step 80 in response to a determination of the necessity for a heat phase in step 78. In certain preferred embodiments, the HPC routine first performs some initialization in step 80 (prior to execution of the heat-phase if warranted in step 92). It then analyzes several criteria in step 82 to determine if heat-phase is truly necessary. If any of the criteria fails in step 84, the DPS routine is alerted in step 86 (with a “True”) that the heat phase either isn't necessary or that its execution is prohibited for one of several reasons. These reasons preferably would include user aborting, sensor failing, minimum temperature being achieved, heating option not being installed, etc. On the other hand, if all the criteria pass in step 84, the initial PWM control of the heaters and fan convection preferably is set up in step 88 in state “0”of the heat-phase state machine whose state handlers exist as cases in the switch. Preferably, the function then alerts the DPS routine in step 90 (with a “False”) that the heat-phase is necessary, has been properly initialized, and should continue.

In certain preferred embodiments of the invention, the DPS routine checks the return value from its initial call of the HPC routine to determine if the heat-phase will be executed in step 94. If the heat-phase will not be executed, the drive pack state machine is set to continue with post-heat-phase processing of the drive pack installation in step 96. Otherwise, if the heat-phase is to continue execution, the drive pack state machine variable is set to the continue execution case in step 92.

For as long as the heat-phase continues, the DPS routine preferably calls the HPC routine, checking each time for indication of heat-phase completion by a return value of “True” from the HPC routine. In certain preferred embodiments of the invention, each time the HPC routine is subsequently called, the DPS routine first checks for heat-phase completion, then updates its countdown timer, and finally executes the heat-phase state machine in step 94 if warranted.

Pulse width modulation is a methodology for controlling device output (heat, light, mechanical motion, electromagnetic waves, etc.) by pulsing the device on and off with fixed or variable periodicity and a variable duty cycle (the on-time to off-time ratio). The heat-phase state machine preferably contains a plurality of pulse width modulation (PWM) levels, L_1 through L_n, each executed in its own state handler represented by a case in the state machine switch. In certain preferred embodiments of the invention, the state handler for each PWM level first analyzes the criteria in step 98 to see if it should advance to the next state's PWM level or should continue with the current one. Since the “n” PWM level is a terminal one (i.e., once entered, it doesn't exit for the remainder of the heat-phase), only PWM levels up to n-1 check level switching criteria.

Preferably, the aforementioned PWM-level switching criteria is based on determinations made in steps 108 and 110 on both temperature feedback from sensors located throughout the peripheral apparatus, and on elapsed time (i.e., when either one of the temperature set-points for a PWM level has been exceeded or delta time allocated for that level has elapsed, the level advances). Set-point values are controlled via a series of static/pre-compile (or optionally downloadable) definitions that are empirically derived by the developer via thermal environment chamber experimentation.

In certain preferable embodiments of the invention, each PWM level controls the heaters 58 and the fans (i.e., within the at least one power supply and/or the at least one fan pack) with unique pulse width modulation characteristics. Preferably, PWM levels are determined by the HPC routine's state machine in steps 100 and 102. However, the actual initialization and control of the heater hardware, via PWM, is done by the H-PWM routine in step 104. Also, the actual initialization and control of the fan hardware, via PWM, is preferably done by the F-PWM routine in step 106.

Both the H-PWM and the F-PWM routines define a specified (especially developer-specified) number of control settings, 0 through “n”. These represent the plurality of power intensity settings that are available to the HPC routine's state machine. The appropriate heater and fan control settings for each PWM level in the HPC routine's state machine are defined via a series of static/pre-compile (or optionally downloadable) definitions that are empirically derived by the developer via thermal environment chamber experimentation.

Preferably, each time a new PWM level is entered by the HPC routine's state machine in step 98, both the H-PWM routine in step 100 and the F-PWM routine in step 102 are called with input parameters indicating the new control setting. Initialization of the hardware (heaters in step 104 or fans in step 106) for the new control setting takes place in a switch with cases for the 0 through “n” levels.

In certain preferable embodiments of the invention, once a new PWM level has been initialized in step 98, the HPC routine's state machine handler for this PWM level must then continuously call the H-PWM routine in step 100 and the F-PWM routine in step 102 at a developer specified minimum frequency (or faster) in order for accurate PWM control to be maintained. The H-PWM and F-PWM routines test timer and temperature parameters in steps 108 and 110 with each call to determine if the proper temperature has been exceeded or the proper time has elapsed for another PWM hardware adjustment. If so, in step 110, these routines reinitialize the timer parameter in step 112 and execute the program steps necessary for the new PWM control output.

PWM control for both the heaters 58 and the fans is unique in that it doesn't just simultaneously pulse all devices on and off. Doing so with the heaters 58 would potentially lead to fatal power rail spiking due to their heavy current draw. Doing so with the fans, in turn, likely would have a detrimental influence on the fan tachometer feedback handler. In order to solve both of these problems, the PWM switching frequency is preferably slowed down considerably, and in the case of the heaters 58, the hardware update function (not depicted, but called from the H-PWM routine) has a built-in temporal stagger between each individual heater control output.

To both accomplish the aforementioned PWM frequency reduction and to simplify the algorithm, a rotating “seed” methodology is preferably implemented, rather than a variable duty cycle. The seed is a pattern of on/off devices that is initialized by the H-PWM and F-PWM routines in steps 104 and 106 at the start of a new PWM level. The ratio of on vs. off devices in the seed controls the overall power intensity.

Each time timers of the H-PWM and F-PWM routines elapse, the control pattern is incrementally shifted by one, and the setting of the last device is circularly rotated to the first device. The seed-pattern methodology thus uses PWM to control output by varying both the frequency period and the duty cycle, rather than varying the duty cycle across a fixed period as in traditional PWM algorithms. This shifting pattern also tends to assure that there will be no cold or hot spots in the heating of the drives 18, and that there will be no convective dead spots in the forced air movement from the fans as all individual controlled elements share an equal active duration during each complete rotation of the seed-pattern.

The fans (i.e., within the at least one power supply and/or the at least one fan pack) are preferably PWM controlled, rather than all simultaneously running during the heat-phase, in order to create an effective efficient interrelationship between warmed air radiating from the guide rail trays 28, cold external air rushing through the intake of the drive protection panel 16, and changes in the ambient temperature. For example, if too much power is applied to fans at an inappropriate time, this will tend to overwhelm the effect of warmed radiated air with cold external air, thus stalling the heating process. Too little power at an inappropriate time results in an ineffective use of warmed radiated air and causes cold convective dead spots across the drives 18, thus similarly impeding the heating process.

In certain preferable embodiments of the invention, the PWM level closed loop feedback scheme disclosed herein, as opposed to a more traditional PID (Proportional, Integral, Differential) feedback scheme, allows for specialized levels as well. For instance, electronic heaters are essentially resistive elements that can have a substantial resistance to temperature curve, i.e., as the temperature increases due to self-heating, the resistance increases as well. Empirical testing found a resistive variability of nearly 30% in the heating elements 58 used. In order to reduce power supply current requirements in later PWM levels, the first PWM heating level was dedicated to pre-heating the heaters 58 using a seed pattern of roughly 50% total heating power. This level takes advantage of the resistance to temperature curve to decrease the current demands by subsequent, increasingly power-hungry levels, thus enabling favorable power supply design requirements.

A portion of a debug port report from a sample embedded processor controlling the heat-phase is described and shown as Table 1. During the heat-phase (lines 4 through 27), a line of real-time statistics is displayed every time the PWM output is altered (once every fifteen seconds). A line is also displayed whenever the PWM level is changed (lines 3, 12 and 26). A section of PWM Level-5 that is not further instructive to the disclosed invention was omitted for brevity.

A breakdown of the debug report's columns is shown as part of the original report (lines 28 through 38). A set-point temperature of +5° C. is configured (col. 7, line 32), which, if achieved, immediately terminates the heat-phase. Two of the drive pack sensors indicate a steady increase in temperature from −31° C. to −5° C. (col. 5 and 6, lines 33 and 34). The on/off states (1=on, 0=off) of the heaters 108 shows the heater states rotating to the right with every PWM update (col. 8, line 31). The same can be said for the four heaters in the fan (col. 10, line 29) as well.

In the PWM levels, the fans (Col. 9, line 30) are preferably left constantly on to protect them from overheating in case a frozen drive pack 14 requiring a heat-phase was placed in principal enclosure 12 preexisting in a warm environment. This could be the case if, for example, the drive pack .14 was transported in an unheated air cargo compartment and then immediately transferred to a warm climate ground station that was already set up with its own principal enclosure.

In a representative progression of the subject process shown, the heat-phase was terminated by the process (line 40) because the maximum duration was achieved prior to the set-point temperature (as discussed above, preferably the achievement of either goal immediately terminates the heat-phase). This is preferably followed by the heat-phase shutdown sequence (lines 41 through 45). Finally, according to a representative embodiment, the state machine's heat-phase state is completed (line 46).

Preferably, the parameters controlling the heat-phase are user configurable via the in-band (the host system data path) and out-of-band (supplemental user communication links) interfaces, and are stored in non-volatile memory when appropriate. Customization of the control parameters allows the user to tailor the heat-phase for particular applications. These user-modifiable parameters may include for example: set-point minimum temperature for heat-phase termination; maximum duration for heat-phase termination; boundary thresholds for heat-phase initiation and over-temperature. emergency shutdown; user run-time abortion for immediate drive spin-up; heat-phase disable for a “battle ready” configuration; etc. Also, optionally, alternate control definitions could be created by the developer upon request and downloaded by the user for special deployment circumstances.

The PWM level closed loop feedback scheme as well as the other routines dedicated to the above described heating system may be implemented in specific hardware (i.e., embedded in silicon in a separate dedicated chip), however, the routines could just as well be configured as software running on processors already incorporated in the RAID controller hardware.

While preferred embodiments of the present invention have been described, it should be understood that a variety of changes, adaptations, and modifications can be made therein without departing from the spirit of the invention and the scope of the appended claims.

[image]

1. A mass media storage system comprising:
a) a housing contained within a principal enclosure and comprised of a plurality of drives, the housing comprising an upper and a lower set of guide rail trays, each of the plurality of drives secured within a drive shuttle, each drive shuttle adapted for insertion between an unoccupied pair of upper and lower guide rail trays; and
b) one or more heater elements each operatively coupled proximate to one of the plurality of drives via the guide rail trays.

2. The system of claim 1, wherein the housing comprises a drive pack.

3. The system of claim 1, wherein the one or more heater elements are located proximate to one of an upper surface and a lower surface of the drives.

4. The system of claim 1, wherein each of the one or more heater elements is operatively coupled to an outer planar side of one of the guide rail trays.

5. The system of claim 4, wherein each of the one or more heater elements has a length and width equal to the length and width of an outer planar side of one of the guide rail trays.

6. The system of claim 4, wherein each of the one or more heater elements is adapted to attach to the outer planar side of one of the guide rail trays utilizing wide thermal range glue.

7. The system of claim 1, wherein each of the one or more heater elements comprises one of the guide rail trays.

8. The system of claim 1, wherein each of the one or more heater elements comprises a thermally conductive, electrically nonconductive, wide thermal range material.

9. The system of claim 1, wherein each of the one or more heater elements is operatively coupled to a corresponding power field effect transistor.

10. The system of claim 9, wherein the housing includes a drive circuit having electrical components and connectors operatively coupled to each of the plurality of drives and each of the power field effect transistors, the drive circuit adapted to provide power individually to each of the plurality of drives and to each of the one or more heater elements.

11. The system of claim 10, wherein the housing includes an enclosure circuit operatively contained within the principal enclosure, the enclosure circuit operatively connected to the drive circuit and adapted to operatively control each heater element and each, of the plurality of drives.

12. A mass data storage apparatus comprising:
a) a principal enclosure including one or more fans;
b) a drive pack contained within the principal enclosure and comprised of a plurality of drives; and
c) one or more heater elements each operatively coupled proximate to one of the plurality of drives; and
d) an enclosure circuit operatively contained within the principal enclosure, the enclosure circuit adapted to operatively control each of the heater elements and each of the fans.

13. The apparatus of claim 12, wherein each of the one or more fans are forced air convection fans located in a posterior region of the principal enclosure.

14. The apparatus of claim 12, wherein the drive pack is comprised of a housing, the housing comprising an upper and a lower set of guide rail trays.

15. The apparatus of claim 14, wherein each of the plurality of drives is secured within a drive shuttle, each drive shuttle adapted for insertion between an unoccupied pair of the upper and lower set of guide rail trays.

16. The apparatus of claim 14, wherein each of the one or more heater elements is operatively coupled to an outer planar side of one of the guide rail trays.

17. The apparatus of claim 14, wherein each of the one or more heater elements comprises one of the guide rail trays.

18. The apparatus of claim 12, wherein the enclosure circuit comprises a plurality of electrical connectors and one or more processors operatively coupled to the drive pack, at least one of the one or more processors adapted to control the operation of one or more of the drives and one or more of the heater elements.

19. The assembly of claim 18, wherein at least one of the processors includes internally programmed operation code, the code involving operations for the at least one processor in order to maintain a correct operating temperature for one or more of the plurality of drives when an initial starting temperature is outside of a range of temperatures required for reliable operation of the drives.

20. The assembly of claim 19, wherein the code includes a pulse width modulated heating program.

21. The assembly of claim 19, wherein the code includes feedback-based processor management of power to the one or more heating elements and to the one or more fans based on one or more temperature sensors operatively coupled within the drive pack, the sensors adapted to be operatively coupled to and monitored by the at least one processor.

22. The assembly of claim 19, wherein the code includes feedback-based processor management of power to each of the plurality of drives based on one or more temperature sensors operatively coupled within the drive pack, the sensors adapted to be operatively coupled to and monitored by the at least one processor.

23. The apparatus of claim 12, wherein the drive pack includes a drive circuit having electrical components and connectors operatively coupled to each of the plurality of drives, the drive circuit adapted to provide power individually to each of the plurality of drives and to each of the one or more heater elements, the drive circuit operatively coupling the enclosure circuit to the drive pack.

24. The apparatus of claim 23, wherein the drive circuit is operatively coupled to a plurality of power field effect transistors, where each of the power field effect transistors is operatively coupled to corresponding heater elements.

25. The apparatus of claim 12, wherein each of the one or more fans is operatively coupled to a power field effect transistor that is operatively coupled to the enclosure circuit, where at least one processor adapted to individually control the operation of the one or more fans.

26. A method of achieving a correct operating temperature for one or more of a plurality of drives within a drive pack contained within a principal enclosure when an initial starting temperature is outside of a range of temperatures required for reliable operation of the drives comprising:
a) monitoring the status of the plurality of drives;
b) determining whether all criteria are met to start heat phase;
c) engaging the heat phase if all the criteria are met; and
d) determining whether the heat phase should be terminated.

27. The method of 26, further comprising the step of programming at least one processor included on an enclosure circuit contained within the principal enclosure with code including a pulse width modulated heating program which includes feedback-based processor management of power to one or more heating elements operatively coupled proximate to the plurality of drives within the drive pack and to one or more fans operatively coupled within the principal enclosure.

28. The method of claim 26, wherein the step of monitoring the status of the plurality of drives further comprises monitoring whether the drive pack is present and determining whether the drive pack is outside of a range of temperatures required for reliable operation of the drives.

29. The method of claim 27, wherein the step of monitoring the status of the plurality of drives further comprises calling up a drive pack services routine within the programmed code within the processor to perform the status monitoring function.

30. The method of claim 26, wherein the step of determining whether all criteria are met to start heat phase further comprises determining whether the user has aborted starting the heat phase, determining whether temperature sensors meant for monitoring the drive pack temperatures are failing, determining whether the minimum temperatures have been achieved, and determining whether the heating option has been installed.

31. The method of claim 30, wherein the step of determining whether all criteria are met to start heat phase further comprises calling up a heat phase control routine within the programmed code within the processor to perform the criteria determining function.

32. The method of claim 26, wherein the step of engaging the heat phase if all the criteria are met further comprises determining the appropriate pulse width modulation levels, providing the operating instruction for the one or more heater elements and the one or more fans, and determining whether the pulse width modulation level should be advanced.

33. The method of claim 32, wherein the step of engaging the heat phase if all the criteria are met further comprises calling up a heat phase control routine within the programmed code within the processor to perform the criteria determining function.

34. The method of claim 26, wherein the step of engaging the heat phase if all the criteria are met further comprises initializing and controlling the heater hardware and executing a “seed” based pulse width modulation algorithm in operating the heater hardware.

35. The method of claim 34, wherein the step of engaging the heat phase if all the criteria are met further comprises calling up a heater-pulse width modulation routine within the programmed code within the processor to perform the criteria determining function.

36. The method of claim 26, wherein the step of engaging the heat phase if all the criteria are met further comprises initializing and controlling the fan hardware and executing a “seed” based pulse width modulation algorithm in operating the fan hardware.

37. The method of claim 36, wherein the step of engaging the heat phase if all the criteria are met further comprises calling up a fan-pulse width modulation routine within the programmed code within the processor to perform the criteria determining function.

38. The method of claim 26, wherein the step of determining whether the heat phase should be terminated further determining whether the temperature set-point has been exceeded or determining whether the time duration has elapsed.

39. The method of claim 38, wherein the step of determining whether the heat phase should be terminated further comprises calling up a heat phase control routine within the programmed code within the processor to perform the criteria determining function.

40. A computer readable medium comprising the instructions for performing the method of claim 26.
